(19) United States
(12) Patent Application Publication
(10) Pub. No.: US 2015/0286299 A1
(43) Pub. Date: Oct. 8, 2015

(54) SCROLL WHEEL FOR USER INTERFACE ON A HAND-HELD INSTRUMENT

(71) Applicant: Thermo Scientific Portable Analytical Instruments Inc., Tewksbury, MA (US)

(72) Inventors: Neil Bacon, Milton, MA (US); Nathaneal Jeyachandran, Medford, MA (US)

(21) Appl. No.: 14/246,487

(22) Filed: Apr. 7, 2014

(51) Int. Cl. G06F 3/0354; G06F 3/041; G01J 3/453; G01N 23/223; G01J 3/44; G01J 3/443

(52) U.S. Cl. CPC G06F 3/03549; G01J 3/44; G01J 3/443; G01J 3/453; G01N 23/223; G06F 3/041; G06F 3/03545

(57) ABSTRACT

A hand-held instrument includes a sample probe for evaluating at least one constituent of a sample; a processor configured with machine executable code stored on machine readable media for controlling the instrument; a display for providing output of the instrument; and, a pointing device for selecting output of the display and providing input to the processor, the pointing device configured for facilitating the selecting while holding the instrument. A method of use, a computer program product and embodiments of sample analyzers are disclosed.

### BACKGROUND OF THE INVENTION

1. Field of the Invention

The invention disclosed herein relates to hand-held instruments, and in particular to a user interface for making user selections.

2. Description of the Related Art

Portable handheld instruments are performing analyses faster and storing more data than previous models. Additionally, the instruments have more complicated menu structures with expanded modes for analysis, utilities and greater data storage. One challenge arises when a display screen is small and approaches the size of a smart phone. In that case, fewer icons are supported on the display, requiring the user to flip through more screens to reach any particular feature. This can be particularly cumbersome when the instrument is deployed in a hazardous or an industrial environment such as one where protective clothing is required.

Thus, what are needed are methods and apparatus to provide users with ready access to the menus and data of a hand-held instrument. Preferably, the methods and apparatus provide for one handed operation.

### SUMMARY OF THE INVENTION

In one embodiment, a hand-held instrument is disclosed. The instrument includes a sample probe for performing an evaluation of a sample; a processor configured with machine executable code stored on machine readable media for controlling the instrument; a display for providing output of the instrument; and, a pointing device for selecting output of the display and providing input to the processor, the pointing device configured for facilitating the selecting while holding the instrument.

In some of the foregoing embodiments, the instrument comprises a pistol grip type of handgrip. In some embodiments, the pointing device comprises at least one of a trackball, a pointing stick and a touch pad; and may include a scroll wheel. The scroll wheel may be disposed on a pistol grip, and may be disposed proximate to a trigger for the instrument. In some embodiments, the scroll wheel operates an encoder for providing the input. In some embodiments, the scroll wheel is mounted upon a shaft that is configured to actuate a microswitch for providing the input, and may include a mechanical detent to provide a tactile feel. In some embodiments, the sample probe is configured for at least one of X-ray fluorescence (XRF) spectroscopy, laser induced breakdown spectroscopy (LIBS), Fourier transform infrared (FTIR) spectroscopy, near-infrared (NIR) spectroscopy and Raman spectroscopy. In some embodiments, the input includes selection of one of a menu item, an icon, and a user option. In some embodiments, the input at least one of: adjusts functionality of the instrument; initiates sampling by the instrument; changes a setting of the instrument; initiates communication by the instrument; and, enters a sub-menu. In some embodiments, the instrument includes a ruggedized configuration. In some embodiments, the constituent includes one of an element and the molecular formulation.

In another embodiment, a method for sampling with a hand-held instrument is disclosed. The method includes selecting the hand-held instrument that includes a sample probe for performing an evaluation of a sample; a processor configured with machine executable code stored on machine readable media for controlling the instrument; a display for providing output of the instrument; and, a pointing device for selecting output of the display and providing input to the processor, the pointing device configured for facilitating the selecting while holding the instrument; and providing input by using the pointing device.

In some of the foregoing embodiments, the method includes providing input includes at least one of scrolling a scroll wheel and depressing a scroll wheel. In some embodiments, providing the input includes at least one of: adjusting functionality of the instrument; initiating sampling by the instrument; changing a setting of the instrument; initiating communication by the instrument; and, entering a sub-menu. In some embodiments, providing input includes at least one of rolling a trackball, manipulating a pointing stick and using a touch pad.

In yet another embodiment, a computer program product stored on machine readable media is disclosed. The computer program product includes machine executable instructions for controlling a hand-held instrument, the instructions including instructions for controlling a hand-held instrument that includes a sample probe for evaluating a sample; a processor configured for executing the instructions; a display for providing output of the instrument; and, a pointing device for providing input to the processor and configured for user manipulation while holding the instrument; operating the pointing device; and receiving input from the pointing device and controlling the instrument according to the input.

In some embodiments of the computer program product, the sample probe is configured for at least one of X-ray fluorescence (XRF) spectroscopy, laser induced breakdown spectroscopy (LIBS), Fourier transform infrared (FTIR) spectroscopy, near-infrared (NIR) spectroscopy and Raman spectroscopy. In some embodiments, the pointing device includes at least one of a trackball, a pointing stick and a touch pad. In some embodiments, the pointing device includes a scroll wheel; and the scroll wheel may operate an encoder for providing the input.

In a further embodiment, a hand-held sample analyzer is disclosed. The analyzer includes a sample probe for surveying a sample; a processor configured with machine executable code stored on machine readable media for controlling the analyzer; a display for providing output of the analyzer; and, a user manipulable pointing device for selecting output of the display and providing input to the processor, the pointing device configured for facilitating the selecting while holding the instrument in an operable configuration.

In some embodiments of the foregoing analyzer, the processor is configured for receiving a signal from the sample probe and identifying at least one constituent of the sample from survey data. In some embodiments, the pointing device comprises a scroll wheel; and the scroll wheel may be oriented proximate to a trigger for initiating the surveying. In some embodiments, the sample probe is configured for at least one of X-ray fluorescence (XRF) spectroscopy, laser induced breakdown spectroscopy (LIBS), Fourier transform infrared (FTIR) spectroscopy, near-infrared (NIR) spectroscopy and Raman spectroscopy.

In yet another embodiment, a hand-held sample analyzer is provided. The analyzer includes a sample probe for surveying a sample, the probe including apparatus for at least one of X-ray fluorescence (XRF) spectroscopy, laser induced breakdown spectroscopy (LIBS), Fourier transform infrared (FTIR) spectroscopy, near-infrared (NIR) spectroscopy and Raman spectroscopy; a processor configured with machine executable code stored on machine readable media for controlling the analyzer; a display for providing output of the analyzer; and, a scroll wheel device for selecting output of the display and providing input to the processor, the scroll wheel disposed near a trigger for initiating the surveying, the scroll wheel also configured for facilitating the selecting while holding the instrument in an operable configuration.

In some embodiments, scroll wheel and the trigger are disposed on a pistol grip of the analyzer.

### BRIEF DESCRIPTION OF THE DRAWINGS

The features and advantages of the invention are apparent from the following description taken in conjunction with the accompanying drawings in which:

FIG. 1 is a schematic diagram depicting a hand-held instrument according to the teachings herein;

FIGS. 2-4 are schematic diagrams of an exemplary embodiment of a pointing device for use in the hand-held instrument of FIG. 1; and

FIG. 5 is an exemplary spectrum provided by the instrument of FIG. 1.

### DETAILED DESCRIPTION OF THE INVENTION

Disclosed herein are methods and apparatus that provides users of hand-held instruments with ergonomic controls that enhance access to features of the instruments. Among other things, the controls provide users with an ability to scroll through menus or data with a single stroke of the index finger. The controls further provide users with an ability to rapidly select a menu icon or data line. In some embodiments, the controls are configured such that ambidextrous use is supported. Additionally, the controls may be environmentally robust and generally immune to dust and water. By incorporation of the controls into a hand-held instrument, manufacturers may make other adaptations to display screens, which also see less use and therefore increased lifespan. Further, the ergonomic controls result in more efficient use of the hand-held instruments. Prior to discussing the ergonomic controls in detail, some context is provided.

As discussed herein, the instrument is generally provided as a “handheld” instrument. This is not to imply that the entire instrument must fit within one's hand. That is, the instrument may have any form factor that is appropriate for field use. More specifically, and as an example, a sampling portion of the instrument may be deployed as a handheld component, while a processing portion, base station or other such component may be deployed remotely. Accordingly, use of shared processing and other techniques to limit the size or otherwise configure the instrument are contemplated by the teachings herein. Generally, the instrument presented herein need merely be defined as adequate for supporting the sampling and analysis needs of field personnel as deemed appropriate by a user, designer, manufacturer or other similarly interested party. Notwithstanding, the non-limiting embodiments presented herein are generally integrated, hand-held instruments.

Generally, the handheld instrument provides for identification of at least one constituent of the sample. In some embodiments, the constituent is an element listed in the Periodic Table of the Elements. In some embodiments, the constituent is a molecular formulation. In some embodiments, the instrument is configured to identify diverse sample constituents (that is, combinations of elements and/or molecular formulations). Accordingly, the handheld instrument may also be referred to as a “sample analyzer,” that provides for sample identification (that is, identification of at least one component of the composition of matter that is manifested as the sample).

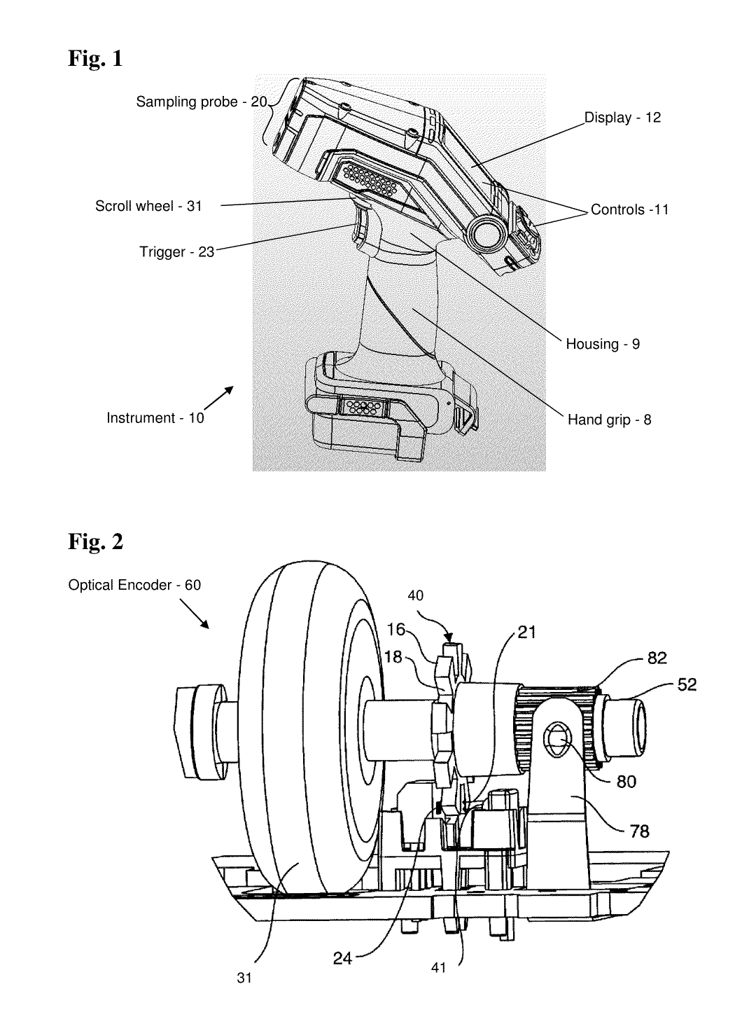

Referring now to FIG. 1, there is shown an exemplary instrument 10. In this non-limiting example, the instrument 10 provides a user with extensive capabilities for field-based surveillance of a sample and sample analysis. Generally, sample surveillance and analysis is performed by spectroscopy techniques. These techniques may use X-ray fluorescence (XRF) spectroscopy, laser induced breakdown spectroscopy (LIBS), Fourier transform infrared (FTIR) spectroscopy, near-infrared (NIR) spectroscopy and/or Raman spectroscopy. That is, the instrument 10 may provide for collection of an X-ray or optical spectrum of absorption, emission, or Raman scattering from a solid, liquid or gas sample. The instrument 10 may also be referred to in some instances as a “spectrometer.”

When the instrument 10 is deployed as an XRF device, the instrument 10 emits gamma or X-rays, and detects secondary emissions from a target. Analyses of the secondary (or “characteristic”) emissions provide for elemental identification of the target material.

When the instrument 10 is deployed as a LIBS device, the instrument 10 emits pulses of optical laser radiation, and detects secondary emissions from a target. Analyses of the secondary (or “characteristic”) emissions provide for elemental identification of the target material.

When the instrument 10 is deployed as an FTIR device, the instrument 10 illuminates a sample with many frequencies of light at once, and measures how much of that beam is absorbed by the sample. The beam is modified to contain a different combination of frequencies, giving a second data point. This process is repeated many times. Afterwards, a processor on board the instrument 10 takes the collected data to estimate absorption at each wavelength. Correlations between absorption data and characteristics for known materials are then made an output to the user.

When the instrument 10 is deployed as an NIR device, the instrument 10 illuminates a sample with near-infrared frequencies of light. When deployed as an NIR device, the instrument 10 includes a source, a detector, and a dispersive element (such as a prism, or, more commonly, a diffraction grating) to allow the intensity at different wavelengths to be recorded.

When the instrument 10 is deployed as a Raman scattering device, the instrument 10 also illuminates the sample with a beam of light. When photons are scattered from an atom or molecule in the sample, most photons are elastically scattered (Rayleigh scattering), such that the scattered photons have the same energy (frequency and wavelength) as the incident photons. However, a small fraction of the scattered photons are scattered by an excitation. These Raman scattered photons have a frequency different from, and usually lower than, that of the incident photons. In a sample, Raman scattering can occur with a change in energy of a molecule due to a transition. The instrument 10 provides resources for collecting an optical signal associated with the Raman scattering, comparing the optical signal with data tables, and outputting correlations to the user.

In some embodiments, the instrument 10 makes use of other technology or combinations of technology for providing sampling surveillance and analysis.

In the exemplary embodiment depicted in FIG. 1, the instrument 10 is provided as a handheld device. The instrument 10 is contained within a housing 9. Housing 9 includes handgrip 8 for users to hold the instrument 10. In this embodiment, the housing 9 is “ruggedized.” That is, the housing 9 is configured with features to provide for survival in a harsh environment. Exemplary features for survival include a jacket of material to protect the exterior of the instrument 10. The jacket of material may additionally be interchangeable (for example to maintain hygiene of the instrument 10). Additionally, components within the housing 9 may be shock mounted, surface mounted or otherwise configured to withstand impact. The housing 9 may further be configured to be moisture resistant, waterproof and/or to withstand chemical degradation (such as to withstand acidity or alkalinity). For example, the instrument may be certified to MIL-STD 810G for ruggedness.

The instrument 10 includes a variety of components for enabling sampling, processing, and appropriate outputting of data and/or results. For example, the user is provided with various user controls 11. Generally, the user controls 11 (as well as other components described herein, collectively referred to as the “user interface”) enable user control of the instrument 10 for initiation of sampling, processing, and communications. Additionally, the user controls 11 enable the user to configure the instrument 10, monitor health of the instrument 10 and to perform other similar tasks. In some embodiments, the user controls 11 may be configured for a particular sampling routine or the like. Generally, the housing 9 and the user controls 11 are sealed from the environment such that the instrument will not be contaminated with sample materials or subjected to the hazards associated with a given sample.

At least one display 12 may be provided with the instrument 10. Generally, the display 12 provides the user with output. The output may include configuration information, status of the instrument 10, semantic information (such as date, time, location information, etc, . . . ), as well as sample characterization, initiation, and analysis information and any other information deemed appropriate. The output may be static (for example, the output may provide identification of the instrument, service records, and the like). The output may be dynamic (for example, the output may display data during collection, such as by displaying an accruing sample spectrum; may be a context sensitive menu, and the like). In some embodiments, the display 12 is provided as a touch sensitive screen to enable user input through the display 12. In an exemplary embodiment, the display 12 is provided as a liquid crystal display (LCD) with a capacitive overlay to enable touch capabilities.

Generally, the instrument 10 includes at least one communications port (not shown). The communications port may include a network interface such as an Ethernet, serial, parallel, 802.11, USB, Bluetooth or other type of interface (not shown). The communications port may be used to provide for remote control, communication of data, receipt of output, shared processing, system backup, and other similar tasks. In some embodiments, the communications port provides an interface to an external computer (such as a personal computer (PC)). When the instrument 10 is connected to a PC (not shown), software installed on the PC may be used for control and enable rapid configuration of the instrument 10. As a matter of convention, software installed on an external unit (such as a PC configured to provide users with improved access and/or control of the instrument) may generally be referred to as a “system manager.”

Generally, the instrument 10 includes an internal power supply (e.g., a battery), memory, a processor, a clock, data storage, and other similar components (not shown). Other output devices may further include a speaker (not shown), such as one configured to provide auditory output such as an alarm. Additional input devices may include a microphone (not shown), such as one configured to receive voice commands from the user.

Generally, the processor is configured to receive input from user and to control the radiation sources, detection systems and analysis components. Accordingly, the processor will also provide appropriate information as output. The instrument 10 may be configured to take advantage of robust processing capabilities, and may therefore include data libraries, substantial memory for data storage, calibration libraries and the like.

A further user interface for controlling the instrument 10 includes trigger 23. Among other things, trigger 23 provides for initiation of sampling and/or analysis with the instrument 10. The output may provide raw data, spectral data, concentration data and other appropriate forms of data.

Generally, the processor is configured to execute application-specific software. That is, the processor is configured to retrieve machine executable instructions stored in machine readable media (such as in the memory or the data storage) and provided for enabling the instrument 10 to perform a selected method for operation. It should be considered that any software provided with the instrument 10 may additionally include data tables, subroutines, links to external resources, and other components as necessary or as deemed appropriate for enabling operation. As one example, the instrument 10 may include at least one library. The at least one library may include substantial chemical data. More specifically, for any given chemical, compound, element or other type of material, the library may include information such as spectral properties, identity, dangerous good classification (NFPA labeling) information, material safety data sheet (MSDS) information and the like. As another example, the instrument 10 may include language libraries for configuring a user interface according to a language of the user.

Among other things, the software may provide output to display 12. Output to the display 12 may include a variety of soft controls 11 for configuring and operating the instrument 10.

In the exemplary embodiment, instrument 10 includes a sampling probe 20 and provides for “point and shoot” style of sample surveillance. As mentioned above, the sampling probe 20 need deploy a particular type of technology for performing sampling, and in some instances, may make use of combinations of technology for performing sampling. In some embodiments, control of the sampling probe 20 and the various components used for performing survey and/or analysis with the instrument 10 is achieved through execution of software. That is, in some embodiments, the processor is configured with appropriate software for recognizing user input, data and other such signals and providing appropriate control signals, communications and/or output.

A further user interface for controlling the instrument 10 includes scroll wheel 31. In some embodiments, the scroll wheel 31 is configured to receive user input from a trigger finger of the user. The scroll wheel 31 may be scrolled to the left, to the right, and may be depressed (that is, compressed into the housing 9). By moving the scroll wheel 31 to the left or to the right, a user may move a cursor or highlighted feature on the display 12 between a variety of user options (such as menu items, icons, and the like—not shown). In some embodiments, once an appropriate option has been selected, the scroll wheel 31 may be depressed to select the option. In some embodiments, the scroll wheel may be configured with a mechanical detent to give the user a tactile feel as an aid to moving the scroll wheel by a specific amount. Selection of the given option may adjust functionality of the instrument 10, initiate sampling by the instrument 10, change a setting of the instrument 10, initiate communication by the instrument 10, or may enter a submenu and reveal additional user options, or provide other results.

In general, the scroll wheel 31 is disposed near the handgrip 8. That is, the user is able to use the scroll wheel 31 while maintaining a grip on the instrument 10. For example, the user may scroll the scroll wheel 31 with an index finger while maintaining the grip with the remaining fingers and palm of the hand. In some embodiments, the instrument 10 includes a pistol grip type of handgrip 8. In some embodiments, the scroll wheel 31 is proximate to the trigger 23 (above, below, or to the side), and the user is able to easily switch between manipulation of the scroll wheel 31 and the trigger 23. In some further embodiments (not shown), the scroll wheel 31 is integrated into or with the trigger 23.

That is, in general, the scroll wheel 31 (and/or other type of pointing device used with or instead of the scroll wheel) is oriented near other controls such that the scroll wheels and the other controls are user manipulable (user adjustable) while maintaining the instrument in an operable configuration (that is, while using the instrument). In short, the scroll wheel (and/or other type of pointing device) provides for selection of options and the like with minimal impact on production.

In the exemplary embodiment shown in FIG. 1, the instrument 10 weighs about 2.5 pounds, is about 9.5 inches tall, about 8 inches long, and about 3 inches wide at its base. The dimensions and weight of the instrument 10 may vary from the foregoing. In another embodiment, the instrument 10 is about 3.5 pounds, about 9.5 inches tall, about 9 inches long, and about 4 inches wide at the widest.

In some embodiments, the instrument 10 includes ergonomic design. For example, the handgrip 8 may be positioned relatively close to the center of mass of the instrument 10, such as with a “pistol grip” style of handgrip. This design provides for reduced user fatigue and increased control over the instrument 10. In some embodiments, the scroll wheel 31 and/or the trigger 23 are positioned on the instrument 10 with regards to user fatigue and facilitating operation of the instrument 10.

Exemplary devices for use as the scroll wheel 31 include pointing devices used in desktop computing. For example, a third input access has been added to many embodiments of computer mice. This input is often referred to as an input on the “Z-axis.”

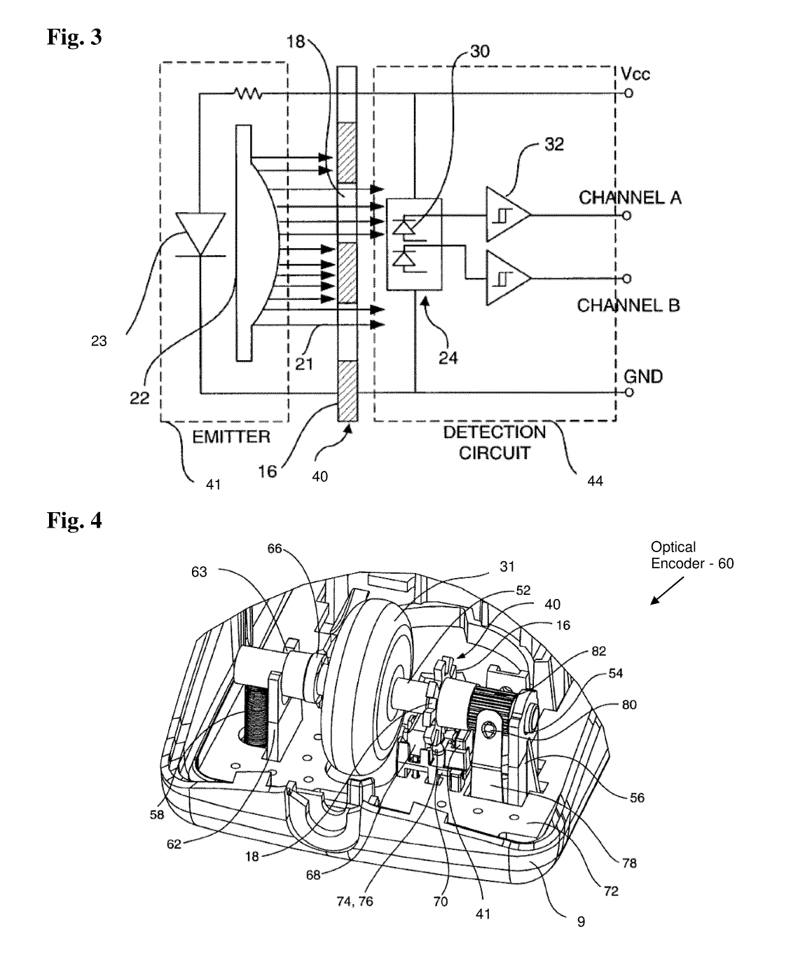

Aspects of an exemplary embodiment of an optical encoder suited for use as the scroll wheel 31 are shown in FIGS. 2, 3 and 4.

Referring to FIGS. 2 and 3, an exemplary embodiment of an optical encoder 60 is shown. The optical encoder 60 includes a shaft 52 disposed through a center of scroll wheel 31 and codewheel 40. Accordingly, rotation of scroll wheel 31 by a user causes rotation of codewheel 40. Adjacent to codewheel 40 are light emitter 41 and detection circuit 44. The codewheel 40 generally includes a plurality of equally-spaced teeth 16 and forming slots 18. The codewheel 40 may be made from a clear plastic or glass disk imprinted with a radially-spaced pattern of lines, commonly called a “mask.” Light emitter 41 may include, for example a light emitting diode (LED) 23. In operation, the light emitter 41 emits light rays that are collimated into a light beam 21 by a lens 22. Detector circuit 44 is disposed opposite the light emitter 41 and may include at least two photodetectors 24, or two sets of photodetectors 24, noise reduction circuitry, and comparators. Suitable components for use as the photodetectors 24 include photodiodes and phototransistors.

When the codewheel 40 is rotated, one of a slotted portion and a lined portion is between the light emitter 41 and detector circuit 44. The light beam 21 passing from the light emitter 41 to the detector circuit 44 is thus interrupted by the part of the codewheel 40 between the pattern of slots or by the radial lines on the codewheel 40. Any portion of the light beam 21 that is not blocked by the codewheel 40 (or the lines that are imprinted on the code will 40) is detected by the photodetectors 24. The photodetectors 24 generally produce an analog output signal that is proportional to the intensity of the light beam 21 that is detected. In general, the output signal produced by each photodetector 24 as the codewheel 40 is turned (at a constant rate) is sinusoidal. The photodetectors 24 may be arranged in a pattern that is a function of the radius and count density of the codewheel 40, so as to produce a quadrature output.

Referring additionally to FIG. 4, the shaft 52 is supported at one end by a bearing 54 in a support bracket 56, and at an opposite (free or floating) end by a coil spring 58, which is displaced over a post (not shown). Lateral movement of the shaft 52 is restricted by a slot 63 defined in a slotted bracket 62, through which the shaft 52 extends. Support bracket 56, the coil spring 58, and slotted bracket 62 all extend upwardly from the interior surface of the housing 9. Coil spring 58 and slot 63 allow the free end of the shaft 52 to pivot in bearing 54 (which is slightly elongated in the vertical direction to allow for such pivoting), permitting the scroll wheel 31 to be vertically displaced when a downward force is applied to it. This vertical displacement enables a collar 66 formed in the shaft to actuate a microswitch (not shown) mounted beneath the collar. The actuation of the microswitch by a user changes a scrolling mode of the display 12. An upward force provided by coil spring 58 biases the free end of the shaft 52 upwardly away from the microswitch when the downward force on the scroll wheel 31 is removed. The teeth 16 and slots 18 of the codewheel 40 pass between light emitter 41 and phototransistors 24, which are mounted in a detector housing 68. The detector housing 68 and the light emitter 41 are mounted to a common base 70, which clips into a printed circuit board (PCB) 72 and defines a location hole 74 that is used to locate the base relative to an alignment pin 76 extending from the interior surface of the housing 9.

The assembly produces a detent action through the use of a metal leaf spring 78, which has a protrusion 80 formed on its upper free end. This protrusion rides against a splined portion 82 of the shaft comprising a plurality of spline teeth separated by spline wells. The lower fixed end of the metal leaf spring is mounted to support bracket 56 (at a point disposed under the PCB). As the shaft is rotated, the protrusion riding on the splined portion of the shaft causes the spring to flex, thereby creating a detent action.

Accordingly, the scroll wheel 31 may be a part of a system such as optical encoder 60, and thus provide users with an ergonomic control for governing operation of the instrument 10. The scroll wheel 31 is not limited to implementation with the optical encoder 60. For example, the scroll wheel 31 may be implemented with a mechanical encoder, a magnetic encoder, or other type of suitable device.

It should be noted that the scroll wheel is merely one embodiment of an ergonomic user interface or pointing device. Other exemplary devices for use as the ergonomic interface include, without limitation, multiple scroll wheels (such as an orthogonally oriented set of two scroll wheels), a trackball, a touch pad (for example, a pressure sensitive touch pad, or a capacitive touch pad), a pointing stick (such as a joystick commonly found on a keyboard of a laptop, and which operates by sensing applied force, by using a pair of resistive strain gauges) and other devices useful for “pointing” (indicating and/or selecting output provided on the display 12, such as through a graphical user interface). Generally, the output selected is provided as input for controlling the instrument. Generally, the ergonomic user interface is oriented to enable one-handed operation of the instrument 10, or at least to facilitate rapid operation of the instrument 10 while maintaining hand-held implementation (that is, holding the instrument in hand).

It should also be noted that the term “display” generally refers to a screen, such as an LCD screen. However, the display may include other forms of indicia. Exemplary forms of indicia include readouts, status lights, auditory output and the like. Accordingly, the term “display” is not limited to information that is displayed on a screen, but is intended to include any mechanism that provides output to a user.

As may be surmised, the instrument 10 provides a versatile system. Part of the versatility is realized by the complexity of the instrument 10. By virtue of the complexity of the instrument 10, it is possible to configure the instrument 10 for improved performance. That is, aspects such as analysis time, order of analyses, power levels and the like may be configured according to types of analyses. More specifically, appropriately adjusting a number of system parameters for the instrument 10 will improve precision and accuracy for given types of analyses.

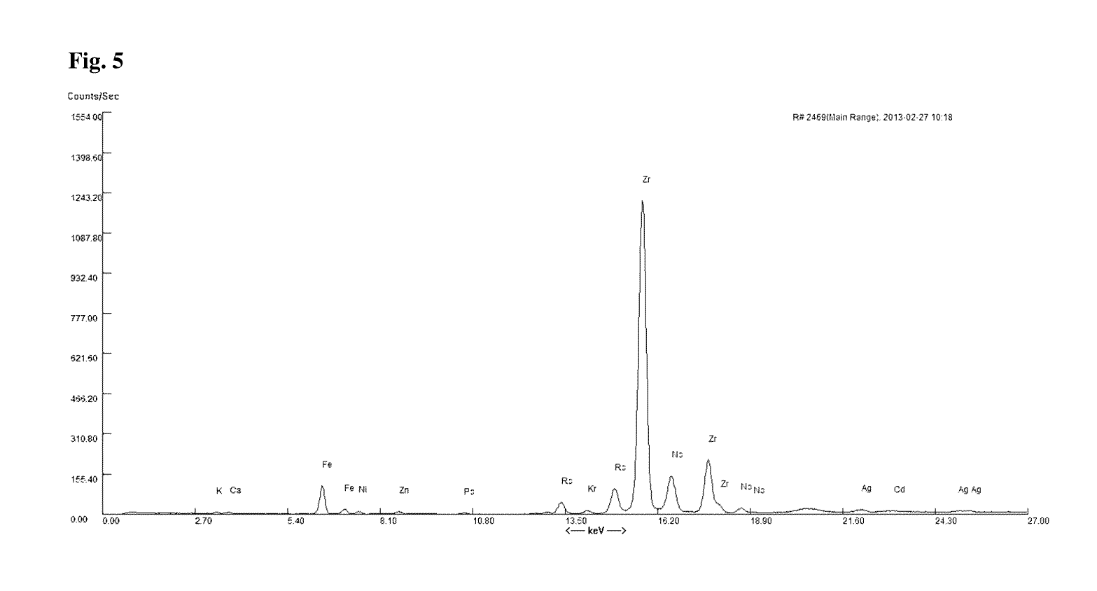

FIG. 5 depicts an exemplary spectrum. The spectrum is provided by sample analysis with the instrument 10, and shows sample peaks. Each of the sample peaks may be associated with constituents of the sample. An exemplary data table associated with the spectrum is provided in Table 1 below.

TABLE 1
Spectral Analysis Results

| Z | ID | Kα₁ | Kα₂ | Kβ₁ | Kβ₂ | Kβ₃ |
|---|---|---|---|---|---|---|
| 20 | Ca | 3.692 | 3.688 | 4.013 | | |
| 26 | Fe | 6.404 | 6.391 | 7.058 | | |
| 30 | Zn | 8.639 | 8.616 | 9.572 | | |
| 36 | Kr | 12.649 | 12.598 | 14.112 | 14.315 | 14.104 |
| 37 | Rb | 13.395 | 13.336 | 14.961 | 15.185 | 14.952 |
| 40 | Zr | 15.775 | 15.691 | 17.668 | 17.97 | 17.654 |
| 41 | Nb | 16.615 | 16.521 | 18.622 | 18.953 | 18.606 |
| 47 | Ag | 22.163 | 21.990 | 24.942 | 25.456 | 24.911 |
| 48 | Cd | 23.174 | 22.984 | 26.095 | 26.644 | 26.061 |

It will be appreciated that any embodiment of the present invention may have features additional to those cited. Sometimes the term “at least” is used for emphasis in reference to a feature. However, it will be understood that even when “at least” is not used, additional numbers or types of the referenced feature may still be present. The order of any sequence of events in any method recited in the present application is not limited to the order recited. Instead, the events may occur in any order, including simultaneously, which is logically possible.

Various other components may be included and called upon for providing for aspects of the teachings herein. For example, additional materials, combinations of materials and/or omission of materials may be used to provide for added embodiments that are within the scope of the teachings herein.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A hand-held instrument comprising:
a sample probe for evaluating at least one constituent of a sample;
a processor configured with machine executable code stored on machine readable media for controlling the instrument;
a display for providing output of the instrument; and,
a pointing device for selecting output of the display and providing input to the processor, the pointing device configured for facilitating the selecting while holding the instrument.

2. The instrument as in claim 1, wherein the instrument comprises a pistol grip type of handgrip.

3. The instrument as in claim 1, wherein the pointing device comprises at least one of a trackball, a pointing stick and a touch pad.

4. The instrument as in claim 1, wherein the pointing device is disposed on a pistol grip.

5. The instrument as in claim 1, wherein the pointing device is disposed proximate to a trigger for the instrument.

6. The instrument as in claim 1, wherein the pointing device comprises a scroll wheel.

7. The instrument as in claim 6, wherein the scroll wheel is mounted upon a shaft that is configured to actuate a microswitch for providing the input.

8. The instrument as in claim 6, wherein the scroll wheel is configured with a mechanical detent to provide a tactile feel.

9. The instrument as in claim 1, wherein the sample probe is configured for at least one of X-ray fluorescence (XRF) spectroscopy, laser induced breakdown spectroscopy (LIBS), Fourier transform infrared (FTIR) spectroscopy, near-infrared (NIR) spectroscopy and Raman spectroscopy.

10. The instrument as in claim 1, wherein the input comprises a selection of one of a menu item, an icon, and a user option.

11. The instrument as in claim 1, wherein the input at least one of: adjusts functionality of the instrument; initiates sampling by the instrument; changes a setting of the instrument;
initiates communication by the instrument; and, enters a sub-menu.

12. The instrument as in claim 1, comprising a ruggedized configuration.

13. The instrument as in claim 1, wherein the constituent comprises one of an element and a molecular formulation.

14. A method for sampling with a hand-held instrument, the method comprising:
selecting the hand-held instrument that comprises a sample probe for evaluating a composition of matter within a sample; a processor configured with machine executable code stored on machine readable media for controlling the instrument; a display for providing output of the instrument; and, a pointing device for selecting output of the display and providing input to the processor, the pointing device configured for facilitating the selecting while holding the instrument; and
providing input by using the pointing device.

15. The method as in claim 14, wherein providing input comprises at least one of scrolling a scroll wheel and depressing a scroll wheel.

16. The method as in claim 14, wherein providing the input comprises at least one of:
adjusting functionality of the instrument; initiating sampling by the instrument; changing a setting of the instrument; initiating communication by the instrument; and, entering a sub-menu.

17. The method as in claim 14, wherein providing input comprises at least one of rolling a trackball, manipulating a pointing stick and using a touch pad.

18. A computer program product stored on machine readable media, the product comprising machine executable instructions for controlling a hand-held instrument, the instructions comprising instructions for:
controlling a hand-held instrument that comprises a sample probe for evaluating a composition of matter within a sample; a processor configured for executing the instructions; a display for providing output of the instrument; and, a pointing device for providing input to the processor and configured for user manipulation while holding the instrument;
operating the pointing device; and
receiving input from the pointing device and controlling the instrument according to the input.

19. The computer program product as in claim 18, wherein the sample probe is configured for at least one of X-ray fluorescence (XRF) spectroscopy, laser induced breakdown spectroscopy (LIBS), Fourier transform infrared (FTIR) spectroscopy, near-infrared (NIR) spectroscopy and Raman spectroscopy.

20. The computer program product as in claim 18, wherein the pointing device comprises at least one of a trackball, a pointing stick and a touch pad.

21. The computer program product as in claim 18, wherein the pointing device comprises a scroll wheel.

22. The computer program product as in claim 21, wherein the scroll wheel operates an encoder for providing the input.

23. A hand-held sample analyzer comprising:
a sample probe for surveying a sample;
a processor configured with machine executable code stored on machine readable media for controlling the analyzer;
a display for providing output of the analyzer; and,
a user manipulable pointing device for selecting output of the display and providing input to the processor, the pointing device configured for facilitating the selecting while holding the instrument in an operable configuration.

24. The analyzer as in claim 23, wherein the processor is configured for receiving a signal from the sample probe and identifying at least one constituent of the sample from survey data.

25. The analyzer as in claim 23, wherein the pointing device comprises at least one of a scroll wheel, a trackball, a pointing stick and a touch pad.

26. The analyzer as in claim 23, wherein the pointing device is disposed on a pistol grip.

27. The instrument as in claim 23, wherein the pointing device is disposed proximate to a trigger for the instrument.

28. The analyzer as in claim 23, wherein the sample probe is configured for at least one of X-ray fluorescence (XRF) spectroscopy, laser induced breakdown spectroscopy (LIBS), Fourier transform infrared (FTIR) spectroscopy, near-infrared (NIR) spectroscopy and Raman spectroscopy.

29. A hand-held sample analyzer comprising:
a sample probe for surveying a sample, the probe comprising apparatus for at least one of X-ray fluorescence (XRF) spectroscopy, laser induced breakdown spectroscopy (LIBS), Fourier transform infrared (FTIR) spectroscopy, near-infrared (NIR) spectroscopy and Raman spectroscopy;
a processor configured with machine executable code stored on machine readable media for controlling the analyzer;
a display for providing output of the analyzer; and,
a scroll wheel device for selecting output of the display and providing input to the processor, the scroll wheel disposed near a trigger for initiating the surveying, the scroll wheel also configured for facilitating the selecting while holding the instrument in an operable configuration.

30. The analyzer as in claim 29, wherein the scroll wheel and the trigger are disposed on a pistol grip of the analyzer.
